(19) United States
(12) Patent Application Publication
(10) Pub. No.: US 2002/0103862 A1
(43) Pub. Date: Aug. 1, 2002

(54) Enabling restricted communications between a plurality of users

(76) Inventor: Jeremy Burr, Portland, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/773,682

(22) Filed: Jan. 31, 2001

(51) Int. Cl. G06F 15/16

(52) U.S. Cl. 709/204

(57) ABSTRACT

A communication protocol particularly amenable to use by children enables communications over various communication protocols without the fear that the children will inappropriately communicate with unauthorized individuals. A list of authorized individuals that a given child may communicate with may be stored on a communication terminal. Before communications are allowed to proceed over a communication network such as the Internet, a check ensures that the intended recipient or sender is an appropriate authorized recipient or sender. A password protection scheme may be utilized to prevent the child from adding inappropriate contacts to the list of authorized individuals.

### BACKGROUND

This invention relates generally to communications between a plurality of processor-based systems.

A variety of communication devices including walkie talkies are available for communications between various terminals. In some cases, the terminals are wired or wireless devices. Communication devices are also available which provide for infrared communications between terminals.

In some cases, communication terminals may be used by children for play purposes. However, a problem may arise if the children are able to communicate with anyone. This is a problem with conventional Internet e-mail communications. By entering various chat/discussion groups, children may ultimately come into contact with undesirable persons who may attempt to misuse the access to the children provided through the communication network. While systems exist for controlling access to the communications network, there is really no way to enforce access limitations.

Thus, conventionally, chat lines and other communication tools available through the Internet are somewhat uncontrolled. In some cases, a monitor may monitor chat sessions for inappropriate language and inappropriate conduct. Communication content can be controlled using commercially available application programs that screen for inappropriate language. However, such applications do not prevent inappropriate access to third parties.

Thus, there is a need for way to implement a communication protocol, suitable for use by children that is capable of preventing contacts with unauthorized persons.

### BRIEF DESCRIPTION OF THE DRAWINGS

FIG. 1 is a schematic depiction of one embodiment of the present invention;

FIG. 2 is a front elevational view of a handheld unit shown in FIG. 1 in accordance with one embodiment of the present invention;

FIG. 3 is a flow chart for software that may be stored on a base station in accordance with one embodiment of the present invention;

FIG. 4 is a flow chart for software that may be stored on a base station in accordance with one embodiment of the present invention;

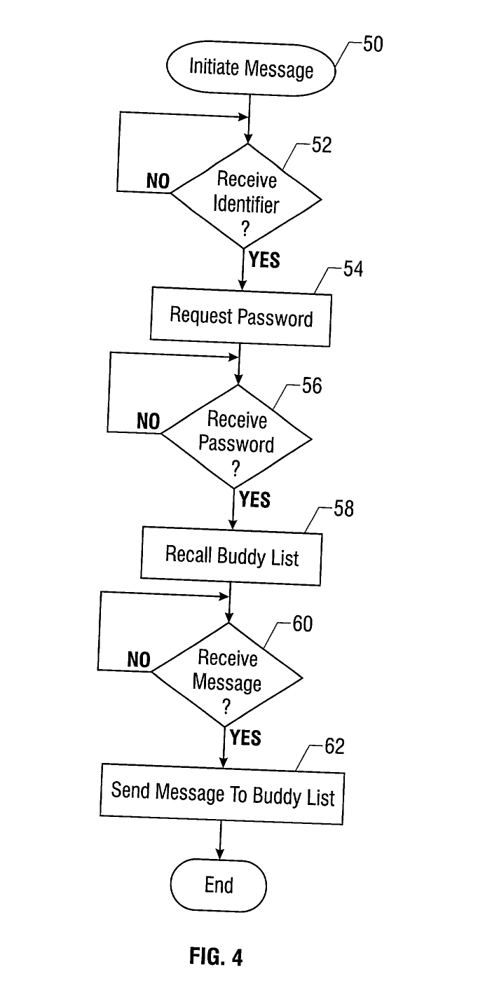

FIG. 5 is a flow chart for software that may be stored on a handheld unit in accordance with one embodiment of the present invention; and

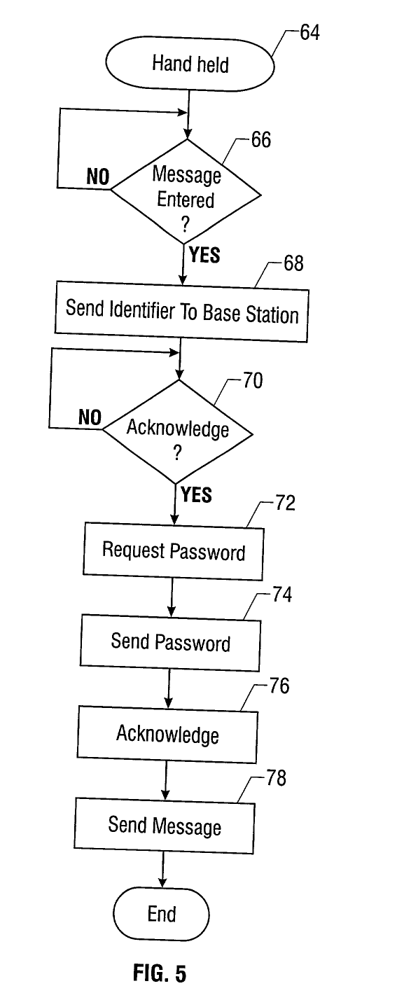

FIG. 6 is a flow chart for software that may be stored on the server in accordance with one embodiment of the present invention.

### DETAILED DESCRIPTION

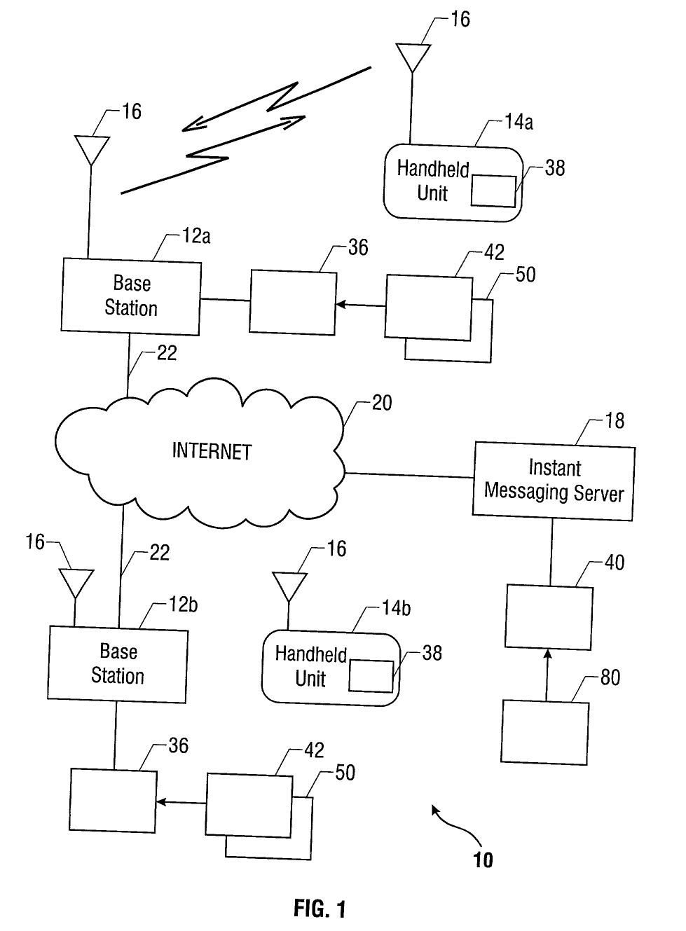

Referring to FIG. 1, a communication system 10 may utilize a variety of communication protocols. For example, communications may be implemented using an electronic mail or chat session communication protocols over the Internet, as examples. In addition, communications may be implemented through wireless signals such as radio frequency or infrared signals.

A handheld unit 14a may include a storage 38 that may store software. In one embodiment, the handheld unit 14a is a processor-based system with a signal transceiver or antenna 16 that implements two-way wireless communications with a base station 12a that also includes a signal transceiver or antenna 16.

Like the handheld unit 14a, the base station 12a may be a processor-based system with a storage 36 that stores the software 42 and 50. As one example, the base station 12a may be a desktop computer system and the handheld unit 14a may be a handheld, battery powered, wireless communication terminal. Similarly, the base station 12a may be a communication terminal that communicates with other terminals, such as the base station 12b, over a link 22 via the Internet 20.

As one example, a chat session may be implemented by an instant messaging server 18. The instant messaging server 18 may communicate with a plurality of base stations 12 over the Internet 20. The instant messaging server 18 may include a storage 40 that stores software 80 for controlling its operation. Thus, a user holding the handheld unit 14a may communicate with a user holding the handheld unit 14b via a combination of communication protocols. A wireless protocol may be utilized between the handheld unit 14a and its associated base station 12a. The base station 12a then may communicate over a link 22 to the Internet 20. The link 22 may be a satellite communication system, a telephone line, or a cable communication system, as examples.

The base station 12a may communicate with the instant messaging server 18 that provides a chat session accessible to both the base station 12a and the base station 12b over the Internet 20. The base station 12b may then communicate, using a suitable wireless protocol, with the handheld unit 14b. While only two users are illustrated, any number of users may be authorized to utilize the system in accordance with some embodiments of the present invention.

The handheld unit 14a, the base station 12a , the base station 12b and the handheld unit 14b may all constitute terminals in the communications system 10. Access to these terminals may be controlled to prevent improper network access via any terminal. For example, children may use the handheld units 14 as toys to communicate with other children. Thus, it may be desirable to control the content of communications between these children and to prevent communications with unauthorized users such as adults who wish to unlawfully interact with children.

To this end, the software 42, 50, 80 and 38 may implement a closed communication system. Only authorized terminals may be accessed from a given terminal. The potential communication targets may be limited through a password protection or other restrictive access scheme. That is, access to a list of authorized target handheld units 14a, stored on base stations 12, may be strictly controlled on a password protected basis. For example, a password protected stored list of authorized targeted contacts inaccessible to the child terminal user, is accessible only to their parents. The children may have a separate password protected ability to use the system without being able to modify the stored contact list. The stored contact list may be stored on the base stations 12 in accordance with one embodiment of the present invention. Thus, each handheld unit 14 can only communicate with those remote stations 12 that are authorized through a password protected list. While the list of appropriate terminals may be modified, it may only be modified upon password access to the stored list of appropriate terminals.

The authorized terminals may be identified by appropriate identifiers. These identifiers may be encrypted in some cases. For example, a rolling code system may be used.

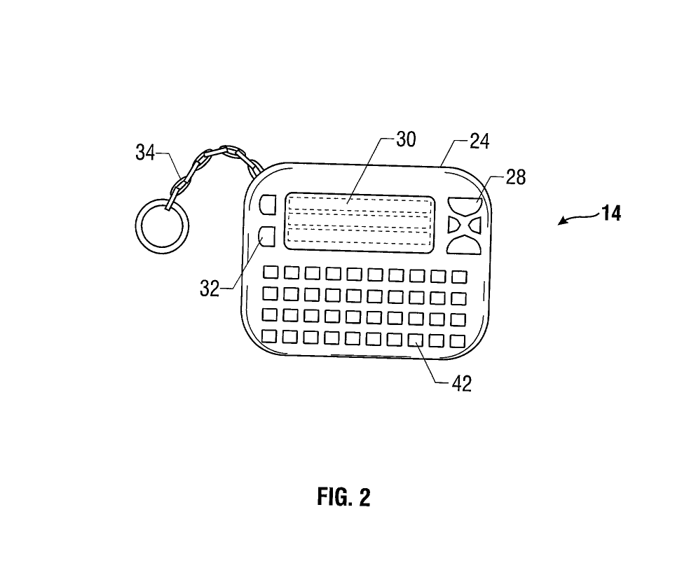

Turning to FIG. 2, the handheld unit 14a may have a hand-sized housing 24. A display screen 30 may display text messages of a few lines in length. In other embodiments, the messages may be in audible or graphical formats. An attachment device 34, such as a key chain, may be provided on the housing 24 for example to make the unit 14 wearable. Other attachment devices 34 such as clips or velcro fasteners may also be used. In addition, control buttons 32 may control the transmission of messages. Scroll buttons 28 may control scrolling through the lines of text displayed on the screen 30. A plurality of keys 42 may enable letters and symbols to be used to create outgoing text messages. While one format for a handheld unit 14 is illustrated in FIG. 2, a variety of other formats for the handheld unit 14 may be utilized as well including those using audible or graphical messages.

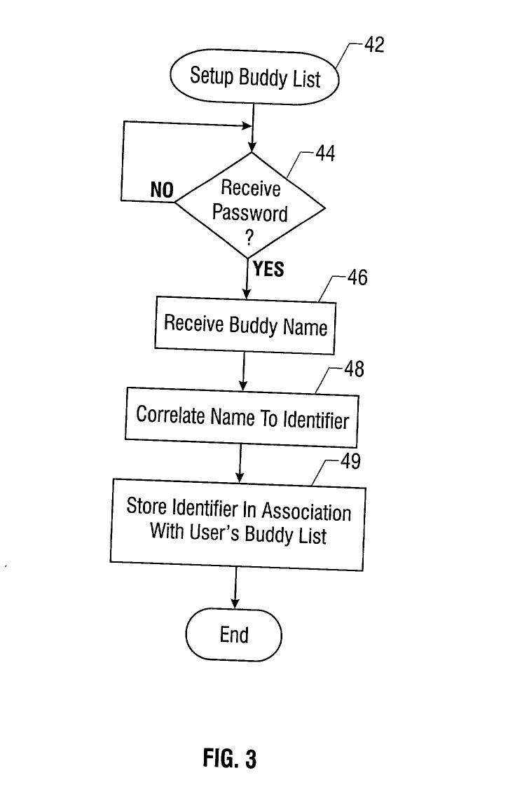

Referring next to FIG. 3, the buddy list setup software 42 may be stored on each base station 12. The buddy list setup software 42 is normally controlled by parents to prevent children from accessing unauthorized adults. Thus, buddy list access may be limited by requiring a restricted access medium such as a password protection system. At diamond 44, a check determines whether an appropriate password has been received at the base station 12a. The password may be entered through a conventional keyboard system using an associated graphical user interface. If so, a new communications network terminal may be identified through a user name as indicated in block 46. The user name may then be correlated with an appropriate identifier that may be stored in a list associated with the software 42. The identifier is then stored in association with the existing list of authorized communication terminals that may be referred to as the user's buddy list. In this way, a parent can add or remove terminals from the list of authorized terminals that a given terminal may access. Thus, the handheld unit 14a may access the base station 12a and attempt to communicate with others who are authorized or unauthorized, but the base station 12a enforces the list of authorized users through the software 42. That is, communication with remote stations through the base station 12a is limited to those authorized persons identified through the software shown in FIG. 3.

Access authorization passwords enable parental control of each authorized buddy on each child's contact or buddy list. Each child may have an individual authorization password that enables the child to initiate messages for transmission to the child's separately authorized contact. However, the child's password cannot be used to modify the child's buddy or contact list.

The base station 12a may also include the initiate message software 50 stored on the storage 36 in accordance with one embodiment of the present invention. When an appropriate identifier is received, as determined in diamond 52, a password request, made in the base station 12, may be directed to the handheld unit 14. When the handheld unit 14 provides the password to the base station 12, a check at diamond 56 determines whether an appropriate password has been received. If so, the buddy list (which is stored on the base station 12a) may be recalled as indicated in block 58. A check at diamond 60 determines whether the intended recipient already exists on the buddy list. If so, the message is sent to the appropriate buddy on the buddy list as indicated in block 62.

In some embodiments of the present invention, messages may be sent from the handheld unit 14a only upon activation of an appropriate password. As a result, if a child loses a handheld unit 14, it may not be immediately utilized by unauthorized persons to make contact with various children on the child's buddy list.

The software 64 stored on the storage 38 within the handheld unit 14, in one embodiment, begins by checking to determine whether a message is entered using the keys 42 for example, as determined at diamond 66. If so, the appropriate identifier for the indicated message recipient or group of recipients is sent to the base station 12 as indicated in block 68. At diamond 70, a check at the handheld unit 14 determines whether the base station 12 has acknowledged the message and its intended recipients as determined in diamond 70. If so, the handheld unit 14 requests a password as indicated in block 72. When the password is received, the password is then sent, as indicated in block 74, to the base station 12a. At block 76, the handheld unit 14 awaits an acknowledgement from the base station 12a and once received, sends the appropriate message on to the base station 12a, as indicated in block 78, in one embodiment of the invention.

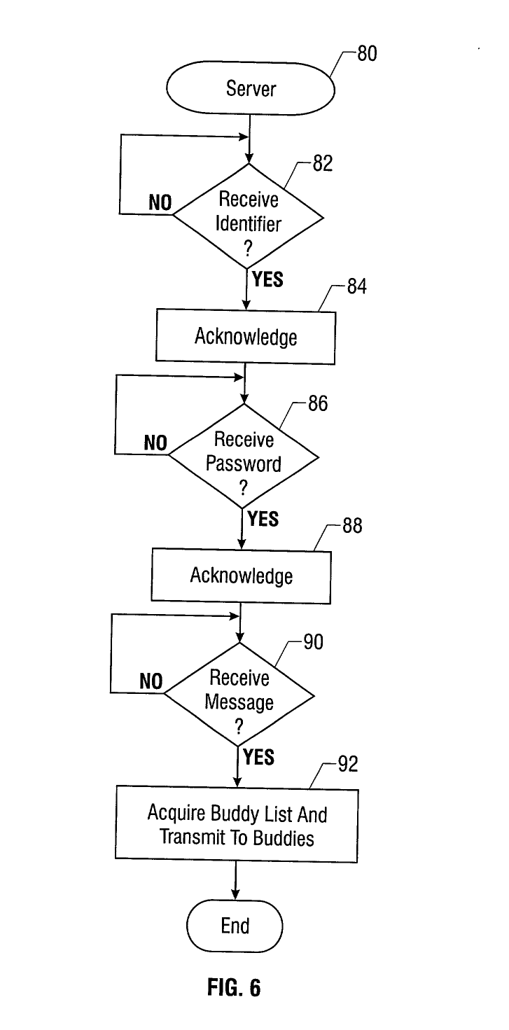

Turning finally to FIG. 6, the software 80 stored on the instant messaging server 18 may implement a Internet Relay Chat (IRC) server in accordance with one embodiment of the present invention. However, while conventional chat sessions may be set up in accordance with established IRC protocols, access to the chat server 18 may be controlled through the base stations 12 which limit the targets who may be addressed. That is, even if a child attempts to insert another addressee into the handheld unit 14a, the base station 12a restricts outgoing communications to only those listed recipients authorized by the child's parents.

Initially, a check at diamond 82 determines whether an identifier has been received from a base station 12. If so, the identifier is acknowledged in an appropriate format as indicated in block 84. Next, a check at diamond 86 determines whether a password has been received from the base station 12. If so, and the password is correct, an acknowledgement may be provided as indicated at block 88.

Next, a check at diamond 90 determines whether a message has actually been received. If so, the buddy list is acquired and the message is then transmitted to the addressed buddy or buddies. Eventually, the buddy list may actually be provided from the base station 12a to the instant messaging server 18 in accordance with one embodiment of the present invention.

As a result, access to and communications between a plurality of children may be implemented in a relatively secure fashion. Software on the base station 12a may monitor for inappropriate words or content. When inappropriate words or content are utilized, they may be screened and deleted at the base station 12. In addition, access to the list of authorized addressees is strictly controlled on a password protected basis implemented at the local base station 12a in one embodiment. Thus, a child's parents can provide the child with a handheld unit 14a that communicates with a particular base station 12a.

The base station 12a may be programmed to receive a uniquely identified communication from a handheld unit 14. That is, the handheld unit 14a may only work with the base station 12a using the appropriate code, such as rolling code or digital tone coded signal, that is recognized by the base station 12a. As a result, the base station 12a may limit those persons or terminals with which a particular handheld unit 14a may communicate.

While the present invention has been described in connection with controlling outgoing communications, the same techniques may be used to control incoming communications. That is communications to a base station 12 may only be passed on to the handheld unit 14 if those communications originate from an authorized terminal.

A user may use multiple terminals at the same time in some embodiments. For instance, a user may simultaneously use one or more audible links, text links and video links. Each of the links may be controlled to limit persons who may be contacted. The contact list may be stored in the unit 14. The communication media may include the Internet as well as a telephone system, using telephones or pagers, and radio or wireless systems.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling communications between a first terminal and selected second terminals;
enabling the storage of a modifiable list of second terminals that the first terminal is able to communicate with; and
enabling the ability to modify said list to be restricted.

2. The method of claim 1 including communicating between a first terminal and a base station and forwarding communications from said first terminal to said base station on to said second terminals.

3. The method of claim 1 including enabling communications between a first terminal that is a handheld unit and said base station using a wireless communication protocol.

4. The method of claim 3 including communicating between said base station and said second terminals at least in part over the Internet.

5. The method of claim 4 including exchanging text messages between said first terminal and selected second terminals.

6. The method of claim 1 including communicating between said first terminal and said selected second terminals through a chat server.

7. The method of claim 6 including storing said modifiable list of second terminals in said base station.

8. The method of claim 7 including blocking communications, from said handheld unit, received by said base station and preventing those communications from proceeding to a second terminal not listed in said modifiable list.

9. The method of claim 1 wherein enabling the ability to modify said list to be restricted includes enabling a requirement for a password to obtain access to said list.

10. The method of claim 1 including requiring a password to initiate an outgoing transmission from said first terminal.

11. An article comprising a medium storing instructions that enable a processor-based system to:
enable communications between a first terminal and selected second terminals;
enable the storage of a modifiable list of second terminals that the first terminal is able to communicate with; and
enable restrictions on the ability to modify said list.

12. The article of claim 11 further storing instructions that enable the processor-based system to communicate with a first terminal and forward communications from said first terminal to said second terminal.

13. The article of claim 11 further storing instructions that enable communications between a first terminal that is a handheld unit using a wireless communication protocol.

14. The article of claim 13 further storing instructions that enable the processor-based system to communicate with said second terminals at least in part over the Internet.

15. The article of claim 14 further storing instructions that enable the processor-based system to exchange text messages between a first terminal and selected second terminals.

16. The article of claim 11 further storing instructions that enable the processor-based system to communicate between said first terminal and said selected second terminals through a chat server.

17. The article of claim 16 further storing instructions that enable the processor-based system to store said modifiable list of second terminals.

18. The article of claim 17 further storing instructions that enable the processor-based system to block communications from said handheld unit and prevent those communications from proceeding to a second terminal not listed in said modifiable list.

19. The article of claim 11 further storing instructions that enable the processor-based system to enable a requirement for a password to obtain access to said list.

20. The article of claim 11 further storing instructions that enable the processor-based system to require a password to initiate an outgoing transmission from said first terminal.

21. A system comprising:
a processor-based device; and
a storage coupled to said processor-based device storing instructions that enable communications between a first terminal and selected second terminals, enable the storage of a modifiable list of second terminals that the first terminal is able to communicate with and enable restrictions on the ability to modify said list.

22. The system of claim 21 including a wireless interface.

23. The system of claim 21 wherein said storage stores instructions that enable said device to communicate with a first terminal and forward communications from said first terminal to said second terminal.

24. The system of claim 21 wherein said storage stores instructions that enable communications between a first terminal that is a handheld unit using a wireless communication protocol.

25. The article of claim 24 wherein said storage stores instructions that enable the processor-based device to communicate with said second terminals at least in part over the Internet.

26. The system of claim 25 wherein said storage stores instructions that enable the processor-based system to exchange text messages between a first terminal and selected second terminals.

27. The system of claim 21 wherein said storage stores instructions that enable the device to communicate between said first terminal and selected second terminals through a chat server.

28. The system of claim 27 wherein said storage stores instructions that enable the device to store said modifiable list of second terminals.

29. The system of claim 28 wherein said storage stores instructions that enable the device to block communications from said handheld unit and prevent those communications from proceeding to a second terminal not listed in said modifiable list.

30. The system of claim 21 wherein said storage stores instructions that enable the device to require a password to obtain access to said list.
